(19) United States
(12) Patent Application Publication
(10) Pub. No.: US 2026/0230862 A1
(43) Pub. Date: Aug. 6, 2026

(54) SYSTEM AND METHOD FOR MONITORING AND TESTING A WIRELESS COMMUNICATION NETWORK

(71) Applicant: BOOST SUBSCRIBERCO L.L.C., Englewood, CO (US)

(72) Inventors: Arnold Foronda Agcaoili, Littleton, CO (US); Akash Dotel, Parker, CO (US); Carl Rickard Hardy Soederberg, Littleton, CO (US)

(21) Appl. No.: 19/047,455

(22) Filed: Feb. 6, 2025

(51) Int. Cl. H04W 24/08; H04W 64/00

(52) U.S. Cl. CPC H04W 24/08; H04W 64/00

(57) ABSTRACT

A system for performing testing of a communication network includes a memory that stores one or more computer readable media that includes instructions and one or more processor devices configured to execute the instructions of the computer readable media to generate a request regarding testing of the communication network, establish a communication session with at least one communication service provider (CSP) test device in a predetermined location within the communication network, transmit the request regarding testing of the communication network to the at least one CSP test device, receive testing data from the at least one CSP test device, store the testing data in a first testing database, and generate at least one report based on the testing data.

### BACKGROUND

Wireless communication networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers and other devices. 5G technologies are capable of supplying much greater bandwidths than was previously available.

### SUMMARY

In accordance with an embodiment, a system for performing testing of a communication network includes a memory that stores one or more computer readable media that includes instructions and one or more processor devices configured to execute the instructions of the computer readable media to generate a request regarding testing of the communication network, establish a communication session with at least one communication service provider (CSP) test device in a predetermined location within the communication network, transmit the request regarding testing of the communication network to the at least one CSP test device, receive testing data from the at least one CSP test device, store the testing data in a first testing database, and generate at least one report based on the testing data.

In accordance wither another embodiment, a method for performing testing of a communication network includes generating a request regarding testing of the communication network, establishing a communication session with at least one communication service provider (CSP) test device in a predetermined location within the communication network, transmitting the request regarding testing of the communication network to the at least one CSP test device, receiving testing data from the at least one CSP test device, storing the testing data in a first testing database, and generating at least one report based on the testing data.

In accordance with another embodiment, a non-transitory, computer-readable medium storing instructions that, when executed by a processor perform a set of functions for performing testing of a communication network, the set of functions including generating a request regarding testing of the communication network, establishing a communication session with at least one communication service provider (CSP) test device in a predetermined location within the communication network, transmitting the request regarding testing of the communication network to the at least one CSP test device, receiving testing data from the at least one CSP test device, storing the testing data in a first testing database, and generating at least one report based on the testing data.

### BRIEF DESCRIPTION OF THE DRAWINGS

The present disclosure will hereafter be described with reference to the accompanying drawings, wherein like reference numerals denote like elements.

FIG. 1 is a schematic block diagram of an example communication network in accordance with an embodiment;

FIG. 2 is a schematic block diagram of an example of a service-based architecture of a communication network in accordance with an embodiment;

FIG. 3 is a block diagram of a system for performing testing of a communication network in accordance with an embodiment;

FIG. 4 is a method for performing testing of a communication network in accordance with an embodiment;

FIG. 5 is a method for testing of a communication network in accordance with an embodiment;

FIGs, 6A-6E illustrate example user interfaces for a system for performing testing of a communication network in accordance with an embodiment; and

FIG. 7 is a schematic block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

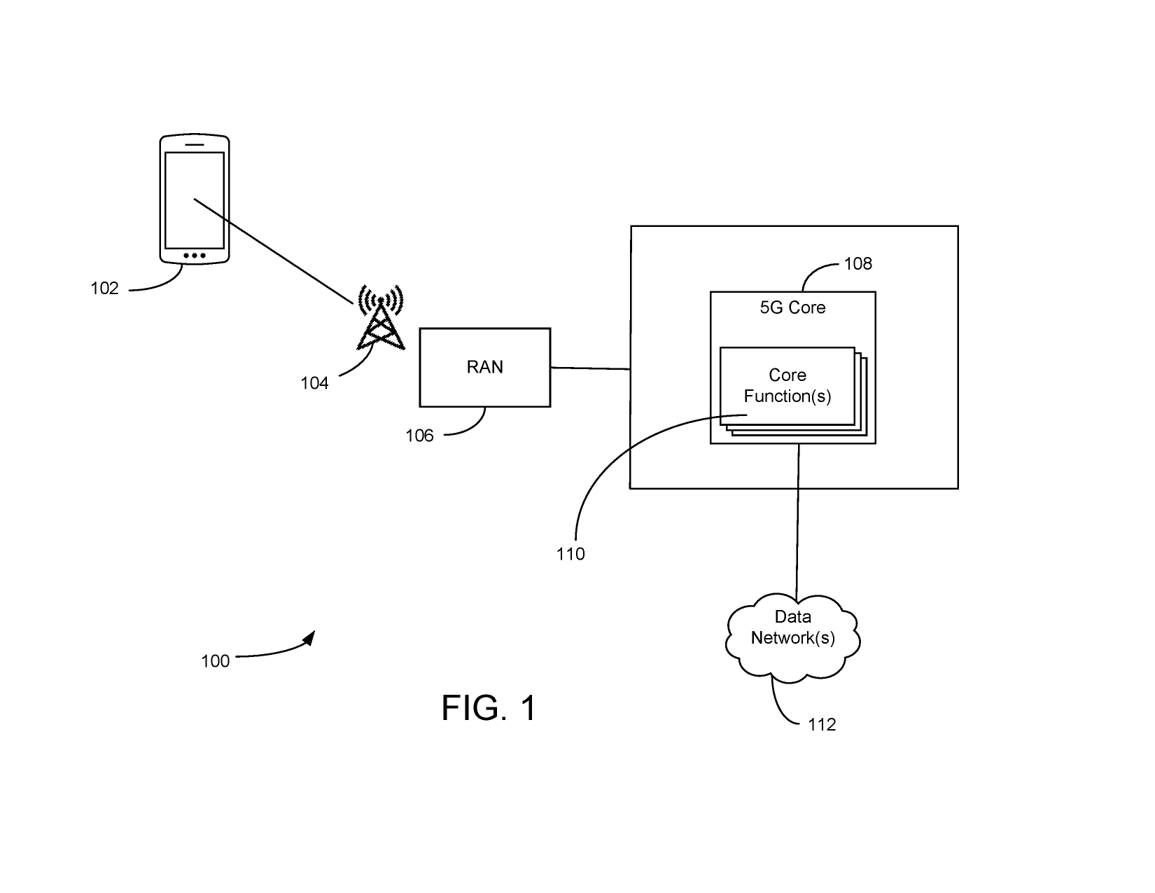

FIG. 1 is a schematic block diagram of an example communication network in accordance with an embodiment. The communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNs) 112 (e.g., the Internet or a private corporate network) using the RAN 106 and 5G core 108. For example, if the external data network 112 is the Internet, the RAN 106 and 5G core 108 can allow the UE device 102 to send and receive data via the Internet. While FIG. 1 illustrates various components of communication network 100, other embodiments of communication network 100 can vary the arrangement, communication paths, and specific components of communication network 100. In some embodiments, the wireless communication network 100 can include fewer, additional, or different components in different configurations than illustrated in FIG. 1. For example, in some embodiments, the wireless communication network 100 may include additional or different UE devices 102.

The communication network 100 may be used to facilitate multiple types of communication sessions, such as, for example, voice calls, video calls, messaging, data transmission, and/or other types of communications. The communication network 100 may represent a portion of a wireless network built around 5G (fifth generation) standards promulgated by standards setting organizations under the umbrella of the Third Generation Partnership Project (3GPP). Accordingly, in some configurations, the communication network 100 may be a 5G network, such as, for example, a 5G cellular network. Such 5G networks, including the communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computer resources. Such general purpose computing resources can be part of a public cloud-computing platform that provides virtual private clouds (VPCs) for multiple clients. On a hybrid cellular network, RAN components of the cellular network are in communication with components of the cellular network executed on a public cloud computing platform such as Amazon Web Services (AWS).

In some configurations, the communication network 100 may be a standalone (SA) network (e.g., a 5G SA network) that utilizes 5G cells for both signaling and information transfer via a 5G packet core architecture. In other configurations, the communication network 100 may be a non-standalone (NSA) network that depends on another network, such as, for example, a control plane of a fourth generation (4G) long-term evolution (LTE) network.

As mentioned, in some embodiments, the UE device 102 can transmit data from one or more applications on the UE device 102 to an external data network (DN) 112, for example, the Internet, via the communication network 100. While FIG. 1 illustrates one UE device 102, in some embodiments, it should be understood that the communication network 100 can support a plurality of UE devices 102. UE device 102 can be various forms of wireless devices that are capable of communication according to the radio access technology (RAT) of the communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on communication networks. For example, after the UE device 102 has established a connection or session with the RAN 106, a user of the UE device 102 may select to stream a video on an application of the UE device 102 via the Internet (e.g., data network 112). The video stream can be provided to the UE device 102 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include one or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such a gNB may be a 3GPP 5G next generation base station that supports communications with the with the UE device 102. While FIG. 1 illustrates a single radio transceiver 104 and a single RAN 106, in practical implementations the communication network 100 may include any number of radio transceivers 104 and/or any number of RAN 106.

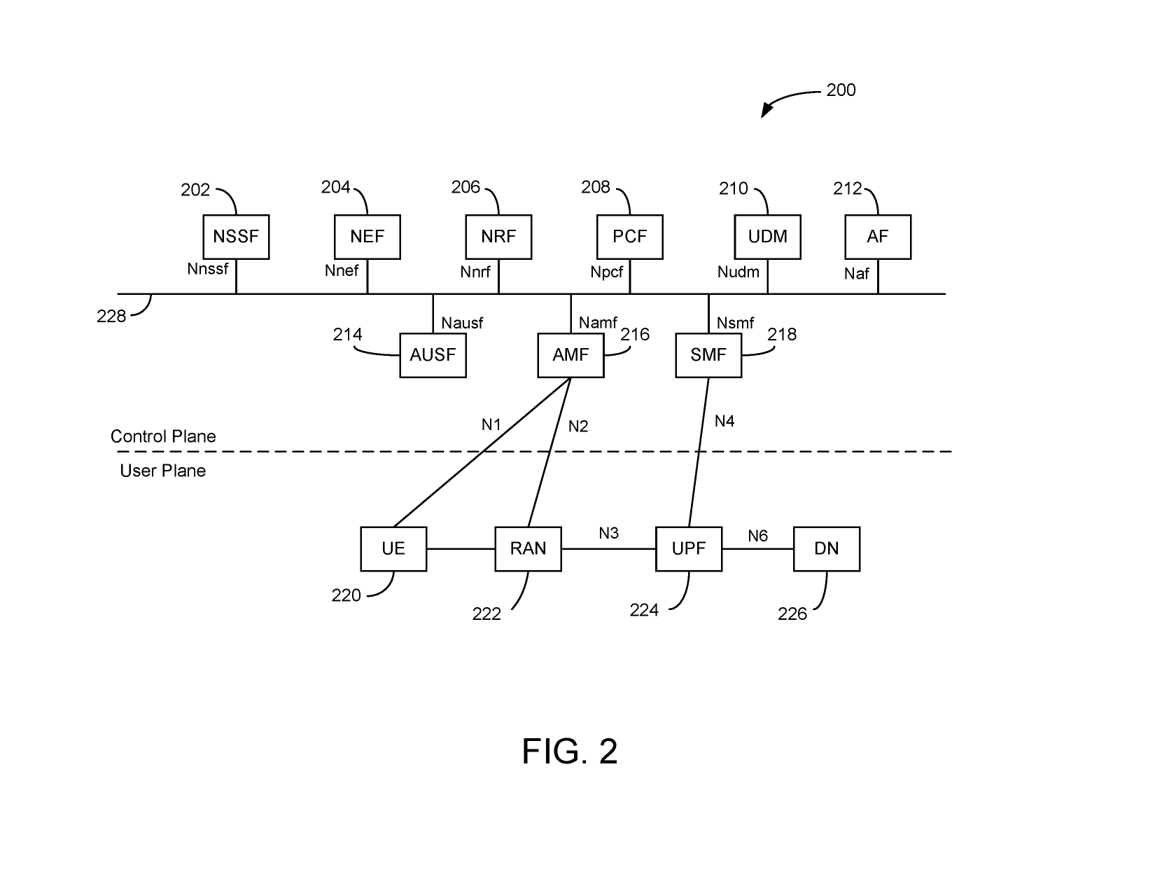

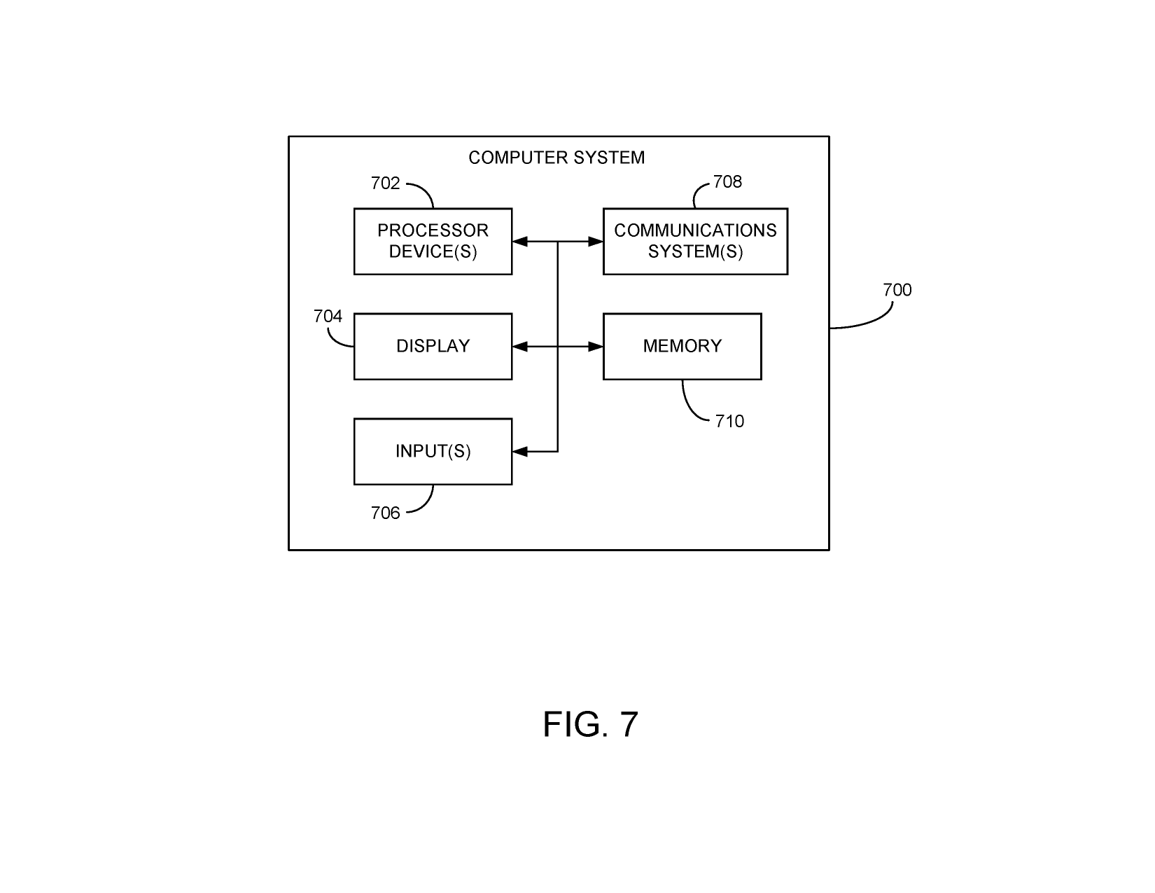

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. For example, in some embodiments, the communication network (e.g., communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). Examples of various core functions 110 are discussed further below with respect to FIG. 2. In some embodiments, the RAN 106 and the 5G core 108 (including core functions 110) may be implemented on a computer system (e.g., computer system 800 discussed below with respect to FIG. 7) such as a server or the functionality of the RAN 106 , the 5G core 109 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC, for example, in a region-based network topology (discussed further below). Within an NDC, multiple regional data centers (RDCs) can be logically present. In some embodiments, each of such one or more regional data centers may execute core functions 110 for a different geographic region or a group of RAN components.

As mentioned, in some embodiments, the communication network 100 can be configured according to a region-based topology. For example, the communication network 100 may be implemented using a cloud computing platform that is logically and physically divided up into various different cloud computing regions (e.g., AWS regions). The cloud computing regions may be based on geographical location of the gNbs; for example, the communication network 100 for a given nation may be divided into a number of geographical regions. Each of the cloud computing regions can be isolated from other cloud computing regions to help provide fault tolerance, fail-over load-balancing, and/or stability and each of the cloud computing regions can be composed of multiple availability zones or markets, each of which can be a separate data center located in general proximity to each other (e.g., within 100 miles). For example, one cloud computing region may have its data centers and hardware located in the northeast of the United States while another cloud computing region may have its data centers and hardware located in California. Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service.

FIG. 2 is a schematic block diagram of an example of a service-based architecture (SBA) of a communication network in accordance with an embodiment. The SBA 200 is divided between a control plane and a user plane. The control plane includes a plurality of network functions (NFs) 202-218. The user plane includes a UE 220 (e.g., UE 102 shown in FIG. 1) in communication with a RAN 222, and NFs (e.g., UPF 224). In FIG. 2, the SBA 200 can be used for providing communication between the UE device 220 and a data network 226 (e.g., the Internet). In FIG. 2, the example 5G core is simplified to show some key components, however, implementations can involve additional components. In some embodiments, the communication network (e.g., communication network 100 shown in FIG. 1), or portion thereof, in which the 5G core is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). For ease of illustration, FIG. 2 only shows a single UE 220 being connected to the RAN 222, however, in practical implementations any number of UEs 220 can be present, limited only by the capacity of the network.

In the example architecture illustrated in FIG. 2, the NFs can include a Network Slice Selection Function (NSSF) 202, a Network Exposure Function (NEF) 204, a Network Repository Function (NRF) 206, a policy control function (PCF) 208, a Unified Data Management (UDM) function 210, an Application Function (AF) 212, an Authentication Server Function (AUSF) 214, an Access and Mobility Management Function (AMF) 216, a Session Management Function (SMF) 218, and a User Plane Function (UPF) 224. The NSSF 202 can provide tailor made logical networks on the physical network, for example, the NSSF can be used by the AMF 216 to assist with the selection of a network slice that will serve a particular UE device. The NEF 204 can expose services and resources over application programming interfaces (APIs) within and outside the 5G core. The NRF 206 can enable 5G network functions (NFs) to register and discover each other via a standards-based application programming interface (API). The PCF 208 can apply session policies for the UE device 220, or other devices, when connecting over, for example, 5G. The UDM 210 can manage network user data in a single, centralized element and can allow for generation of authentication vectors, user identification handling, NF registration management, and retrieval of UE device individual subscription data for slice selection. The AF 212 can interact with the 3GPP Core Network in order to provide serviced, for example, to support one or more of application function influence on traffic routing, application function influence on service function chaining, accessing the NRF 212, interacting with the PCF 216, time synchronization service, IP multimedia subsystem (IMS) interactions with the 5GC, or packet data unit (PDU) set handling. The AUSF 214 can allow the AMF 216 to authenticate the UE and access services of the 5G core. The AMF 216 can perform operations like mobility management, registration management, connection management, UE-based authentication, etc. The SMF 218 can interact with the decoupled data plane, can perform internet protocol (IP) address allocation and management for UE devices (e.g., UE device 220), user plane selection, and packet routing in conjunction with the UPF 224, etc. The UPF 224 can perform user plane operations, such as maintaining protocol data unit (PDU) sessions, packet routing and forwarding, inspection policy enforcement for the user plane, Quality of Service (QoS) handling, providing data access to the UE 220, etc. A PDU session can provide connectivity between applications on the UE device 220 and the DN 226 (e.g., the Internet). The SMF 218 can also be responsible for creating, updating, and removing PDU sessions, selecting particular UPFs 224 on which to anchor PDU sessions when new UE devices 220 appear on the communication network, and managing session context with the UPF 224. Together with the UPF 224, the SMF 218 can maintain a record of PDU session state by means of a PDU Session ID.

The SBA 200 may also include a plurality service-based interfaces (SBIs) 228 to provide access to or communicate with the various NFs. As illustrated, such service-based interfaces may include an Nnssf interface for the NSSF 202, an Nnef interface for the NEF 204, an Nnrf interface for the NRF 206, an Npcf interface for the PCF 208, an Nudm interface for the UDM 210, an Naf interface for the AF 212, an Nausf interface for the AUSF 214, an Namf interface for the AMF 216, and an Nsmf interface for the SMF 218. In some embodiments, the UE 220 can communicate with the RAN 222 wirelessly, for example, via a radio transceiver 104 (shown in FIG. 1). The AMF 216 and the UE 220 can communicate signals or messages with another over, for example, an N1 interface. The AMF 216 and the RAN 222 can communicate signals or messages with one another over, for example, an N2 interface. The RAN 222 and the UPF 224 can communicate signals and data with one another over, for example, an N3 interface. The SMF 218 and the UPF 24 can communicate signals or messages with one another over, for example, an N4 interface. The UPF 224 can send and receive signals and data with the Internet 226 over an Internet interface, for example, an N6 interface. The AMF 216 and the SMF 218 can communicate signals and messages with one another over an interface, for example, an N11 interface.

The above-listed NFs and interfaces are intended to be illustrative and not exhaustive. In practical implementations, the SBA 200 may include additional NFs and other network entities, such as an SNPN Authentication and Authorization Function (NSSAAF), a Network Data Analytics Function (NWDAF), a United Data Repository (UDR), a 5G-Equipment Identity Register (5G-EIR), a Charging Function (CHF), a Service Communication Proxy (SCP), a Security Edge Protection Proxy (SEPP), a Hone Subscriber Service (HSS), a Home Location Register (HLR), a Binding Support Function (BSF), a Policy and Charging Rules Function (PCRF), a Call Session Control Function (CSCF), a Session Border Control Function (SBC), a Media Resource Function (MRF), a Short Message Service Function (SMSF), or a Rich Communication Services Application (RCS).

As discussed above, a communication network can include many different infrastructure components (e.g., core 108 (including core functions 110). RAN 106, etc.) and can be used to facilitate multiple types of communication sessions (e.g., voice calls, video calls, messaging (e.g., short message service (SMS), multimedia messaging service (MMS), data transmission, etc.). To monitor and manage devices, applications and network performance, an operator or administrator of the communication network may perform testing of the communication services provided by the communication network (e.g., connectivity testing). For example, an administrator may perform testing after implementing a change request for the network to confirm that the communication network is operating properly. In another example, an administrator may perform testing in response to a customer complaint (e.g., regarding performance of a particular application) to try to reproduce the issue or problem and help identify one or more components that may be causing a disruption of service or reduced quality of service, etc. Current systems and methods for testing, however, often require additional hardware components and are not scalable across diverse regions if the communication network and device types (e.g., UE types and manufacturers) which can slow down the testing process, reduce efficient and impact the overall quality of network performance.

The present disclosure describes systems and methods for performing testing of a communication network. In particular, the systems and methods for performing testing of a communication network described herein can enable continuous monitoring and remote management of devices (e.g., UEs) and applications, can provide a platform for remote access, and can enable the assessment of user (i.e., customer) interactions across various device types (e.g., UE types and manufacturers) and regions of the communication network. Accordingly, the disclosed systems and methods can provide a unified platform for remote access, automated testing and real-time monitoring. Advantageously, the disclosed systems and methods for performing testing of a communication network utilize test device that are operated by the communication service provider (CSP) of the communication network (e.g., smartphones or other mobile UE devices utilized by field engineers, sales personnel, etc. of the CSP, mobile UE devices located (or installed) on a mobile entity (e.g., a vehicle)) while the CSP test devices are located in different regions of the communication network. Operators or administrators of the communication network can utilize the disclosed systems and methods to, for example, remotely manage CSP test devices for wireless testing, schedule automated tests to be performed by the CSP test devices, and review testing data and reports including, for example, detailed execution repots and performance metrics.

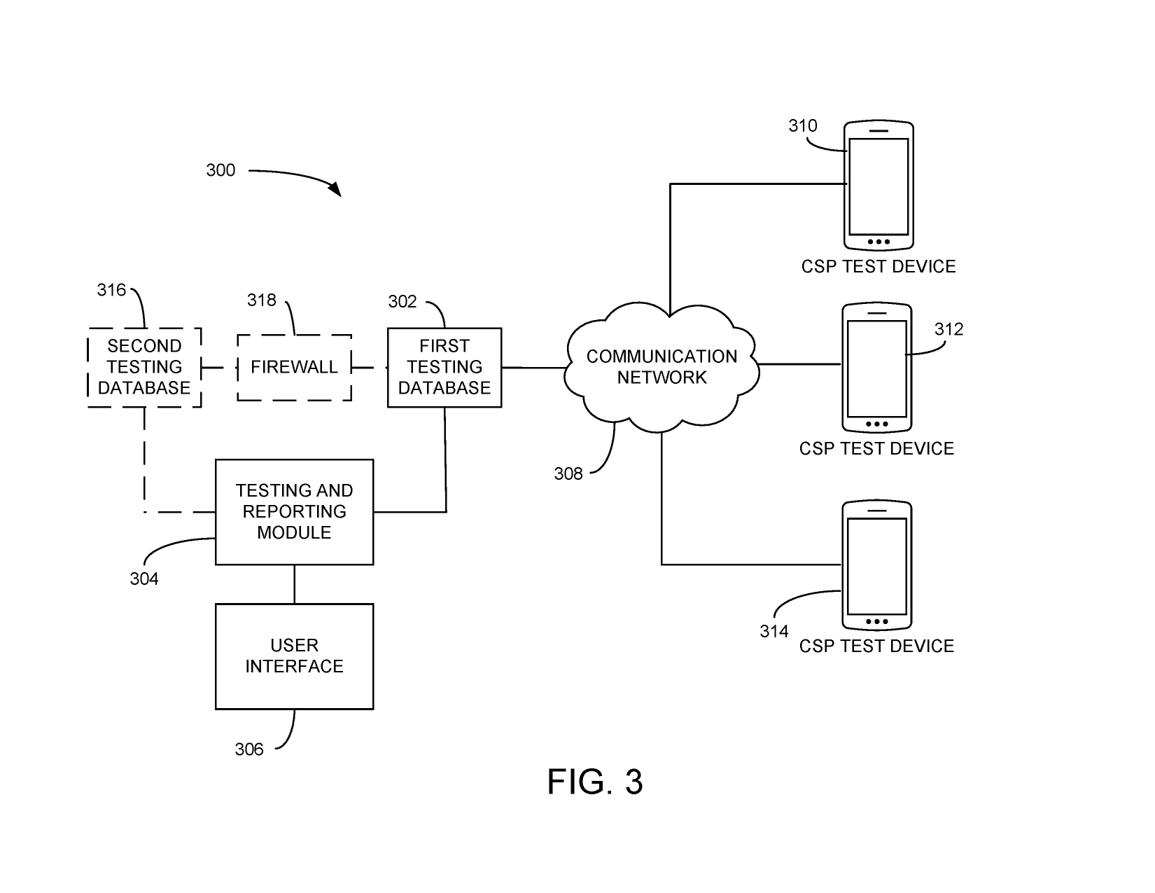

FIG. 3 is a block diagram of a system for performing testing of a communication network in accordance with an embodiment. The system 300 can include a first testing database 302, a testing and reporting module 304, a user interface 306, a communication network 308, a plurality of communication service provider (CSP) test devices 310, 312, 314, an optional second testing database 315 and an optional firewall 318. In some embodiments, the system 300 can be associated with a CSP or carrier that provides communication network services using the communication network 308 (e.g., communication network 100 shown in FIG, 1). System 300 can be used to perform monitoring and testing of the communication network 308, for example, devices, applications, network performance, etc., using the first testing database 302, the testing and reporting module 304, the user interface 306 and one or more CSP test devices 310, 312, 314. Communication network 308 can be a communication network (e.g., a 5G network, an O-RAN 5G network, etc.) such as, for example, the communication network 100 described above with respect to FIG. 1. The communication network 308 can be used to facilitate multiple types of communication sessions, such as, for example, voice calls, video calls, messaging, data transmission, and/or other types of communications. The first testing database 302 and the testing and reporting module 304 can be configured to communication with one or more CSP test devices 310, 312, 314 over the communication network 308. The CSP test devices 310, 312, 314 can be located at a particular location in the communication network 308, e.g., a geographic location such as a city, a portion of a city such as a downtown area, a county, etc. In one example, the CSP test devices 310, 312, 314 can be located with personnel of the CSP, e.g., a technician, a field engineer, sales personnel, etc., that are out in the field in the particular location or the CSP test device 310, 312, 314 can be located (or installed) on a mobile entity (e.g., a vehicle). In some embodiments, each CSP test device 310, 312, 314 can be a mobile UE device such as, for example, a smartphone, a cellular phone, a laptop computer, a tablet, etc. As mentioned, in some embodiments, each CSP test device can be a mobile UE device located (or installed) on a mobile entity (e.g., a vehicle) out in the field that may be moving throughout or between locations in a particular geographic area. In some embodiments, each CSP test device 310, 312, 314 can include one or more components of a computer system (e.g., computer system 700 discussed below with respect to FIG. 7. For example, in some embodiments, a CSP test device 310, 312, 314 can include at least a processor (e.g., processor device(s) 702 shown in FIG. 7), a communication system (e.g., communication system 708 shown in FIG. 7), and a memory or data storage (e.g., memory 710 shown in FIG. 7) and can be configured to store and execute scripts or other software programs. While three CSP test devices 310, 312, 314 are illustrated in FIG. 3, it should be understood that different numbers of CSP test devices (e.g., fewer, more) can be located in a particular geographic location in the communication network 308.

The user interface 306 can be configured to allow an operator or administrator of the communication network 308 (e.g., communication network 100 shown in FIG. 1) to interact with the system 300, for example, to provide inputs to the testing and reporting module 304 (e.g., to initiate testing, to program CSP test devices 310, 312, 314 for automated testing, to request reports, etc.) and to display outputs, for example, received from the testing and reporting module 304, or to display, for example, testing data retrieved from the first testing database 302 or the second testing database 316. The user interface 306 (e.g., inputs 706 of a computer system 700 shown in FIG. 7) can include any suitable input devices and/or sensors that can be used to receive the user input, such as a keyboard, a mouse, a touchscreen, a microphone, a graphical user interface (GUI), a voice user interface (VOI), mechanical switches, buttons, knobs, etc. The user interface 306 can also include a display that can be used to display, for example, outputs such as reports generated by the testing and reporting module 304, and testing data from the first testing database 302 or the second testing database 316. In some embodiments, the user interface 306 may be implemented on a computer system (e.g., computer system 700 discussed below with respect to FIG. 7). Example graphical user interfaces for the system 300 are discussed below with respect to FIGS. 6A-6E.

Inputs received using the user interface 306 can be provided to the testing and reporting module 304. The testing and reporting module 304 can be configured to generate requests regarding testing of the communication network that can be transmitted to one or more of the CSP test devices 310, 312, 314, for example, to initiate a test case of a communication service, device or application, to program one or more CSP test devices 310, 312, 314 for automated testing (e.g., a CSP test device can be programmed to automatically run test cases at a predetermined time interval), to collect or retrieve testing data from one or more of the CSP test devices 310, 312, 314 based on automated testing and store the testing data in the first testing database 302. In some embodiments, the test case can be based on services provided by the communication network such as, for example, short calls, long calls, and various data services (e.g., video calls, uploading data, downloading data, SMS, MMS, call forwarding service, conference call, etc.). A test case can be configured to determine whether the specific service, a device or component of the communication network 308 used in providing the service, or an application is operating properly and to ensure that an end user (or customer) has access to the services the communication network 308 should be providing for them. The requests regarding testing generated by the testing and reporting module 304 can be transmitted to one or more of the CSP test devices, for example, using signal messaging over the communication network. As mentioned, in some embodiments, the request regarding testing can be configured to initiate a test case on demand (e.g., in response to a customer complaint regarding a particular service or application). Accordingly, the testing and reporting module 304 can transmit the request to remotely access (e.g., remotely login) one or more of the CSP test devices 310, 312, 314 and initiate the test case. In some embodiments, a CSP test device 310, 312, 314 can be configured to perform testing (e.g., one or more test cases for one or more different services or applications) automatically at a predetermined time interval (e.g., every hour, every three hours, one per day, etc.) and store the testing data on the CSP test device. In such embodiments, the request regarding testing can be configured to collect testing data for the automated testing from CSP test devices 310, 312, 314. As discussed further below, the request regarding testing can also be used to transmit, for example, a script, to program a CSP test device 310, 312, 314 for automated testing.

The CSP test devices 310, 312, 314 can transmit testing data acquired from performing the test case to the first testing database 302 over the communication network 308, for example, using signal messaging. In some embodiments, the CSP test device 310, 312, 314 can be configured to transfer or transmit the testing data acquired from automated testing to the first testing database 302 at a predetermined time. As mentioned, testing data received from the CSP test devices 310, 312, 314 in a particular location can be stored in the first testing database 302. In some embodiments, the testing data can include, for example, scoring regarding performance of the communication network 308 for the test case (e.g., a mean opinion score (MOS) for voice quality), key performance indicators (KPIs), success or failure of one or more KPIs, device information regarding the CSP test device(s) 310, 312, 314 (e.g., model, device identifier, status (e.g., busy or idle), operating system, geographical location, battery, etc.) used for the test, network information regarding the communication network 308 during the test (e.g., signal strength, network connection, SIM, hardware, WiFi, etc.), radio logs associated with the test, etc. As illustrated in FIG. 3, the first testing database 302 can be in communication with the communication network 308. In some embodiments, a second testing database 316 can be provided that is isolated, for example, using a firewall 318, from the communication network 308. In such embodiments, the second testing database 316 can retrieve testing data (e.g., a copy of the testing data) from the first testing database 302. The testing and reporting module 304 can be in communication with the second testing database 316 and access the testing data from the second testing database 316 rather than the firs testing database 302. According, the testing and reporting module 304 does not need to be connected to the first testing database 302 and the communication network 308 to access testing data.

The testing and reporting module 304 can be configured to retrieve testing data from the first testing database 302 or the second testing database 316. The testing and reporting module 304 can also be configured to generate reports based on the testing data retrieved from the first testing database 302 or the second testing database 316. In some embodiments, the reports can include, for example, testing data, graphs, dashboards, tables, charts, metrics, etc. generated based on the testing data. In some embodiments, the report generated by the testing and reporting module 304 can be stored in data storage (e.g., memory 710 of computer system 700 shown in FIG. 7). In some embodiments, an operator may view the report on a display of the user interface 306 (e.g., display 704 shown in FIG. 7). In some embodiments, an operator (e.g., a network administrator or engineer) may use the report and the testing data to, for example, evaluate a communication service of the communication network, evaluate an application on the communication network, evaluate and monitor network performance, troubleshoot an issue or problem, etc.

In some embodiments, the testing and reporting module 304, first testing database 302, second testing database 316, and firewall 318 may be implemented on a computer system (e.g., computer system 700 discussed below with respect to FIG. 7). While FIG. 3 illustrates various components of the system for testing of a communication network, other embodiments of the system can vary the arrangement, communication paths, and specific components of the system. In some embodiments, the system can include fewer, additional, or different components in different configurations than illustrated in FIG. 3.

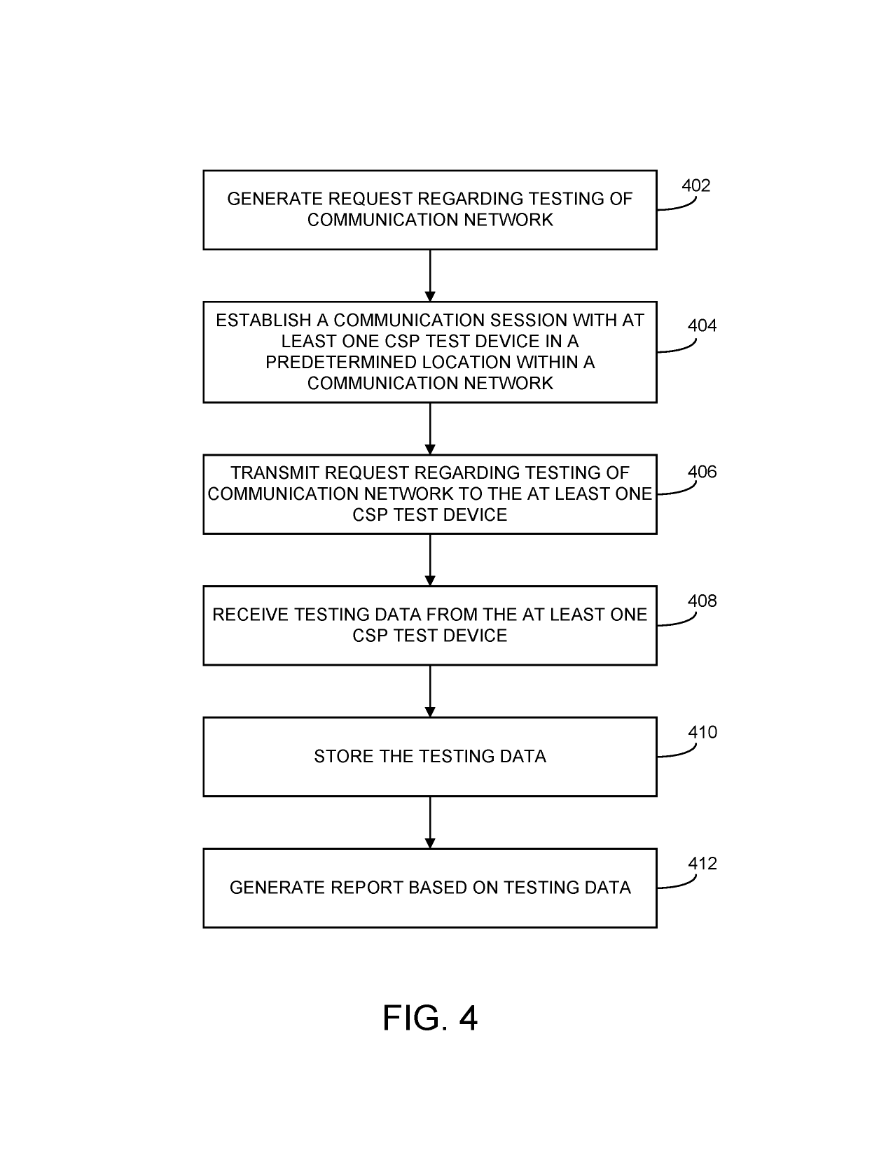

FIG. 4 is a method for performing testing of a communication network in accordance with an embodiment. The process illustrated in FIG. 4 is described as being carried out by the system in FIG. 3. However, in some examples, the process of FIG. 4 may be implemented by a different system. Although the blocks of the process are illustrated in a particular order, in some embodiments, one or more blocks may be executed in a different order than illustrated in FIG. 4, or may be bypassed.

At block 402, a request regarding testing of a communication network 308 (e.g., communication network 100 shown in FIG. 1) can be generated, for example, using a testing and reporting module 304. In some embodiments, the request regarding testing can be configured to initiate a test case on demand (e.g., in response to a customer complaint regarding a particular service or application). In some embodiments, the request regarding testing can be configured to collect testing data from one or more CSP test devices 310, 312, 314 where the testing data is generated by automated testing performed by the CSP test device 310, 312, 214 at predetermined time intervals (e.g., making a call every hour, transmitting SMS messages every three hours, etc.). As mentioned, the testing can include a test case that can be based on services provided by the communication network 308 such as, for example, short calls, long calls, and various data services (e.g., video calls, uploading data, downloading data, SMS, MMS, call forwarding service, conference call, etc.). At block. 404, a communication session over the communication network 308 can be established with at least one CSP test device 310, 312, 314 at a predetermined location, for example, e.g., a geographic location such as a city, a portion of a city such as a downtown area, a county, etc., within the communication network 308.

At block 406, the request regarding testing of the communication network can be transmitted (e.g., using signal messaging) to the at least one CSP test device 310, 312, 314 over the communication network 308. As mentioned, in some embodiments, the request regarding testing can be configured to remotely access at least one of the CSP test devices 310, 312, 214 in the predetermine location and initiate a test case on demand. For example, after a change request has been implemented, a test case (e.g., a short call, a video call, etc.) can be performed to ensure that the network performance is satisfactory (e.g., based on KPIs) based on the testing data determined from performing the test case. In another example, in response to a customer complaint regarding an issue or problem with service on the communication network 308 (e.g., latency), a test case can be performed to, for example, attempt to duplicate the problem and troubleshoot what components of the communication network 308 may be the source of the problem. In another example, when a customer identifies problems with the quality of voice call, the test can include transmitting an audio file to one or more of the CSP test devices 310, 312, 314 in the predetermined location. If the audio file loses packets (which can distort the audio file) going through the communication network 308 (e.g., the core 108 or RAN 106, both shown in FIG. 1), the CSP test device 310, 312, 314 can evaluate the voice quality using, for example, a mean opinion score (MOS). The MOS can then be included in the testing data provided to the first testing database 302. As mentioned, in other embodiments, the request regarding testing can be configured to collect testing data from the CSP test devices 310, 312, 314 generated based on automated testing performed by the CSP test device. For example, a CSP test device 310, 312, 314 can be configured to execute a call every hour, or send an MMS message every three hours, etc. and can store the testing data for the automated test cases locally in memory (e.g., memory 710 shown in FIG. 7) on the CSP test device 310, 312, 314. As mentioned, the testing data can include, for example, scoring regarding performance of the communication network 308 for the test case (e.g., a mean opinion score (MOS) for voice quality), key performance indicators (KPIs), success or failure of one or more KPIs, device information regarding the CSP test device(s) 310, 312, 314 (e.g., model, device identifier, status (e.g., busy or idle), operating system, geographical location, battery, etc.) used for the test, network information regarding the communication network 308 during the test (e.g., signal strength, network connection, SIM, hardware, WiFi, etc.), radio logs associated with the test, etc.

At block 408, testing data can be received from the at least one CSP test device 310, 312, 314. In some embodiments, the CSP test devices 310, 312, 314 can transmit testing data acquired from performing the test case or cases to the first testing database 302 over the communication network 308, for example, using signal messaging. At block 410, the testing data can be stored in data storage, for example, in the first testing database 302. As mentioned, in some embodiments, the testing data can also be stored in a second testing database 316 that is isolated, for example, using a firewall 318, from the communication network 308. In such embodiments, the second testing database 316 can retrieve testing data (e.g., a copy of the testing data) from the first testing database 302.

At block 412, a report can be generated (e.g., using the testing and reporting module 304) based on the testing data. In some embodiments, the testing and reporting module 304 can retrieve the testing data from a first testing database 302 connected to the communication network 308. In some embodiments, the testing and reporting module 304 can retrieve the testing data from the second testing database that is isolated from the communication network 308. In some embodiments, the report can include, for example, for example, testing data, graphs, dashboards, tables, charts, metrics, etc. generated based on the testing data. In some embodiments, the generated report can be provided (e.g., transmitted) to the user interface 306 and, for example, displayed on a display (e.g., display 704 shown in FIG. 7) and viewed by an operator. In some embodiments, the generated report can be stored in data storage (e.g., memory 710 shown in FIG. 7).

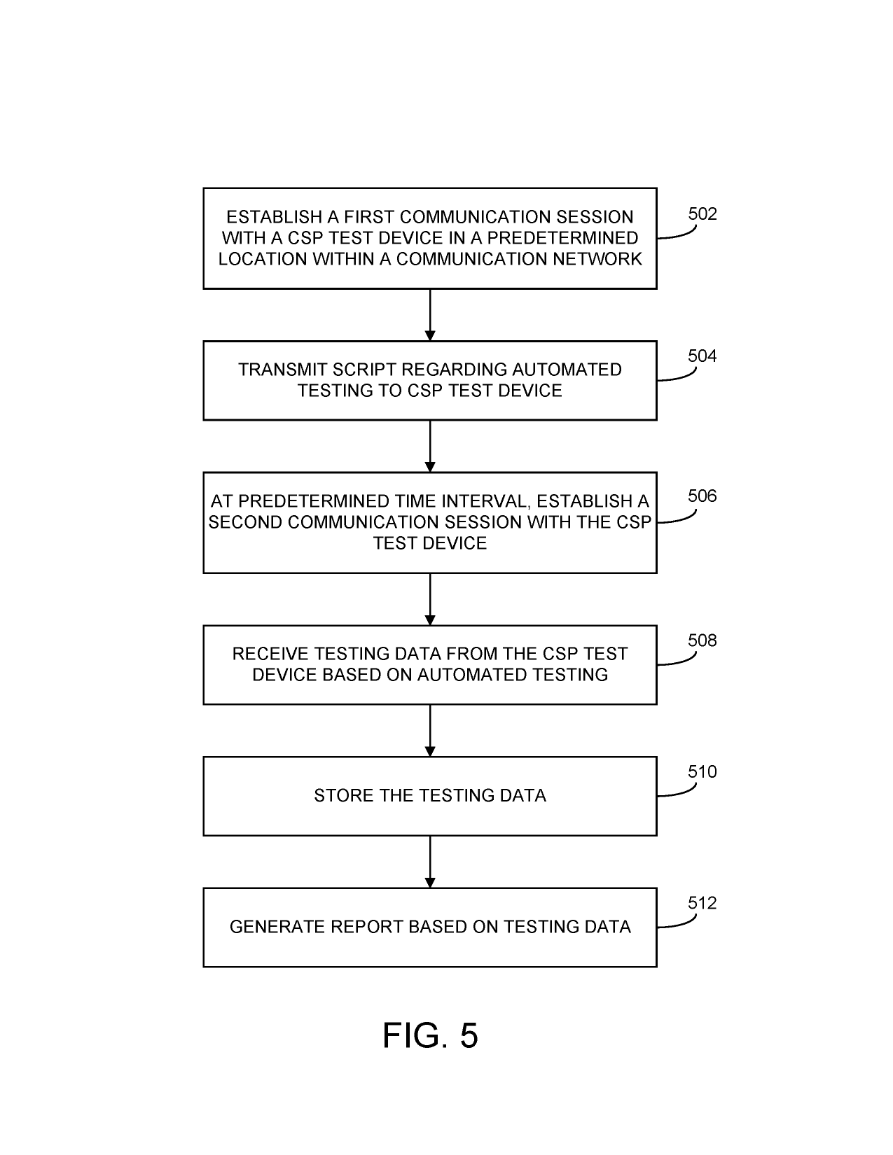

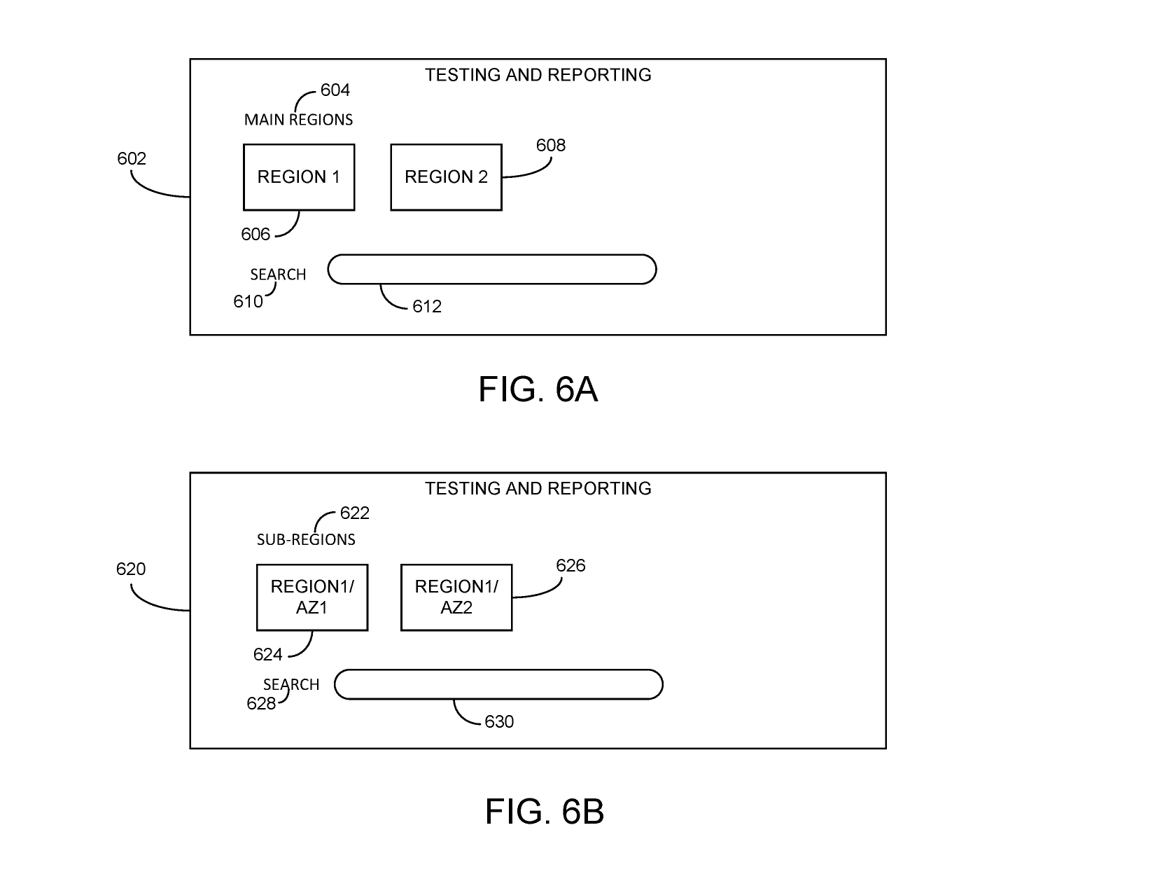

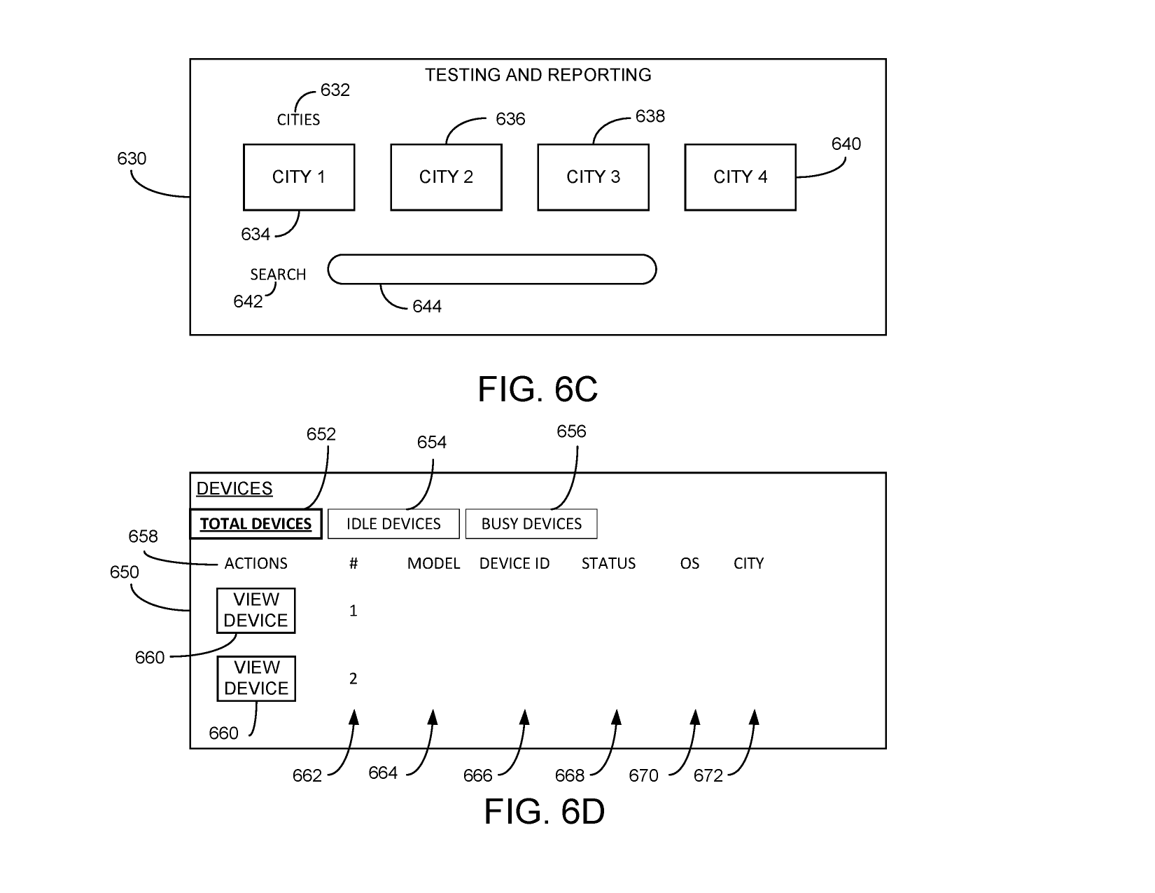

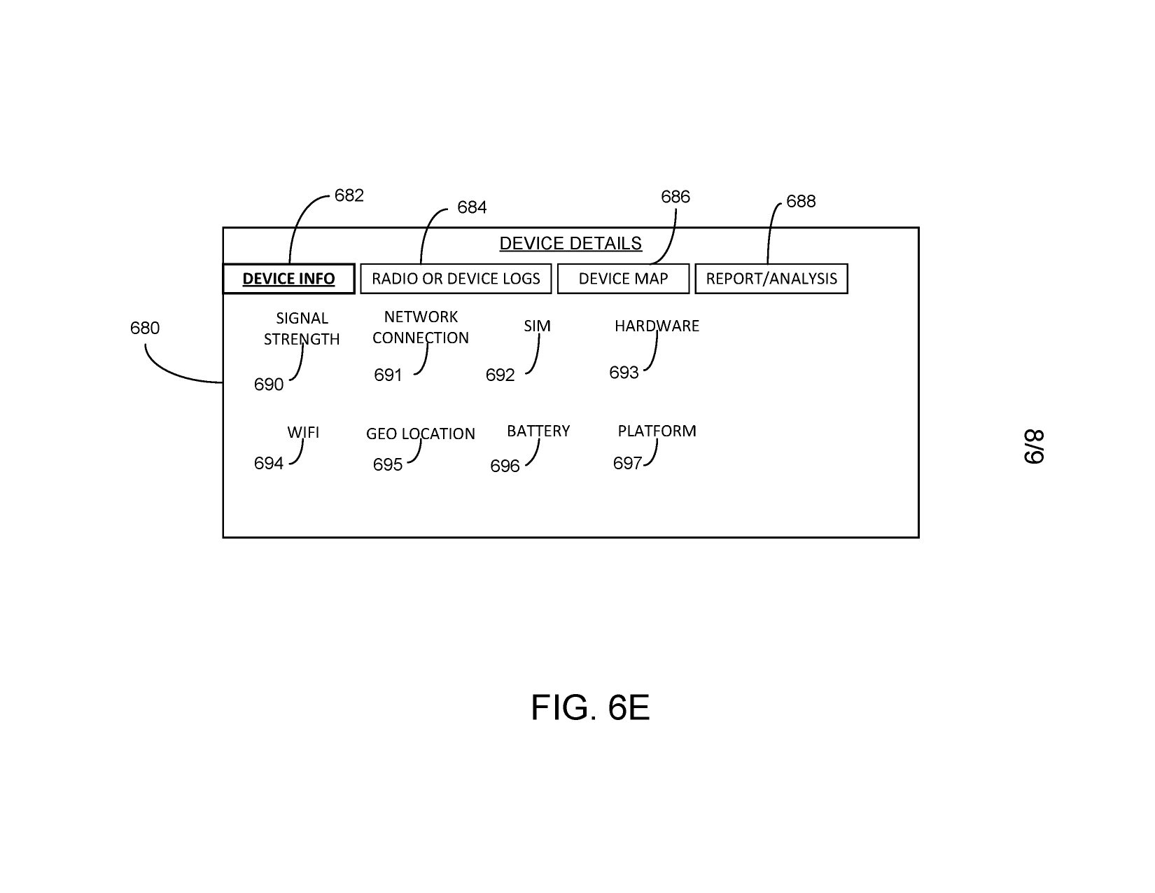

As mentioned, in some embodiments, the testing and reporting module 304 can also be configured to generate a request regarding testing that can be used to transmit, for example, a script, to program a CSP test device 310, 312, 314 for automated testing at predetermined time intervals. FIG. 5 is a method for performing testing of a communication network in accordance with an embodiment. The process illustrated in FIG. 5 is described as being carried out by the system in FIG. 3. However, in some examples, the process of FIG. 5 may be implemented by a different system. Although the blocks of the process are illustrated in a particular order, in some embodiments, one or more blocks may be executed in a different order than illustrated in FIG. 5, or may be bypassed.

At block 502, a first communication session over the communication network 308 can be established with at least one CSP test device 310, 312, 314 at a predetermined location, for example, e.g., a geographic location such as a city, a portion of a city such as a downtown area, a county, etc., within the communication network 308. At block 504, a script regarding automated testing can be transmitted to the at least one CSP test device 310, 312, 314. The script can be software that is configured to perform automated testing when executed by the CSP test device 310, 312, 314 (e.g., by a processor deice of the CSP test device). In some embodiments, the automated testing can include testing (e.g., running one or more test cases) of one or more communication services or applications at a predetermined time interval (e.g., every hour, every three hours, once per day, etc.). For example, the script executed by the CSP test device 310, 312, 314 can be configured to make a call every hour or transmit an SMS message every three hours. The testing data for the automated testing can be stored in memory (or data storage) on the CSP test device 310, 312, 314 (e.g., memory 710 shown in FIG. 7).

At block 506, at a predetermined testing data collection time interval, a second communication session over the communication network 308 can be established with the least one CSP test device 310, 312, 314 at the predetermined location within the communication network 308. The predetermined testing data collection time interval can be, for example, one per day, once every two hours, once every hour, etc. The second communication session can be configured to collect testing data for the automated testing performed by the CSP test device(s) 310, 312, 314. At block 508, testing data acquired by the at least one CSP test device 310, 312, 314 in accordance with the script for automated testing can be received from the at least CSP test device. In some embodiments, the one or more CSP test devices 310, 312, 314 can transmit the testing data acquired from automatically performing a test case or cases to the first testing database 302 over the communication network 308, for example, using signal messaging.

At block 510, the testing data can be stored in data storage, for example, in the first testing database 302. As mentioned, in some embodiments, the testing data can also be stored in a second testing database 316 that is isolated, for example, using a firewall 318, from the communication network 308. In such embodiments, the second testing database 316 can retrieve testing data (e.g., a copy of the testing data) from the first testing database 302. At block 512, a report can be generated (e.g., using the testing and reporting module 304) based on the testing data. In some embodiments, the testing and reporting module 304 can retrieve the testing data from a first testing database 302 connected to the communication network 308. In some embodiments, the testing and reporting module 304 can retrieve the testing data from the second testing database 316 that is isolated from the communication network 308. In some embodiments, the report can include, for example, for example, testing data, graphs, dashboards, tables, charts, metrics, etc. generated based on the testing data. In some embodiments, the generated report can be provided (e.g., transmitted) to the user interface 306 and, for example, displayed on a display (e.g., display 704 shown in FIG. 7) and viewed by an operator. In some embodiments, the generated report can be stored in data storage (e.g., memory 710 shown in FIG. 7).

As mentioned, a graphical user interface (e.g., user interface 306 shown in FIG. 3 and input 706 shown in FIG. 7) may be provided to allow a user or operator (e.g., a network administrator) to interact with the system 300 for performing testing of a communication network. FIGs, 6A-6E illustrate example user interfaces for a system for performing testing of a communication network in accordance with an embodiment. In FIGS. 6A-6C, GUIs 602, 620, 630 can be provided that all a user to select a location (e.g., a geographic location) in the communication network (e.g., communication network 308 shown in FIG. 3) in order to view the CSP test devices located in the location. In FIG. 6A, the GUI 602 provides a number of inputs related to the main regions 604 in the communication network, for example, a first region 606 and a second region 608. For example, as mentioned the regions 606, 608 can correspond to different cloud computing regions (e.g., AWS regions, for example, the communication network may be divided into a number of geographical regions. For example, one cloud computing region may have its data centers and hardware located in the northeast of the United States while another cloud computing region may have its data centers and hardware located in California. The GUI 602 can also include a search input 610 that can include a data entry field 612 to receive a search query from the operator to search for a specific region of the communication network. In response to an operator selecting one of the regions 606, 608, the GUI 620 shown in FIG. 6B) can be displayed that can include inputs related to sub-regions 622 of the selected region of the communication network. For example, each sub-region can correspond to an availability zone. In FIG. 6B, the GUI 620 illustrates a first availability zone (AZ1) 624 and a second availability zone (AZ2) 626. The GUI 620 can also include a search input 628 that can include a data entry field 630 to receive a search query from the operator to search for a specific sub-region of the selected region in the communication network. In response to an operator selecting one of the sub-regions 624, 626, the GUI 630 shown in FIG. 6C) can be displayed that can include inputs related to locations (e.g., geographic locations such as a city, a portion of a city such as a downtown area, a county) in the selected sub-region. In FIG. 6C, the GUI 630 includes input for a plurality of cities 632 in the selected sub-region. In this example, the GUI 630 illustrates a first city 634, a second city 636, a third city 638, and a fourth city 640. The GUI 630 can also include a search input 642 that can include a data entry field 644 to receive a search query from the operator to search for a specific location (e.g., city) in the elected sub-region.

In response to an operator selecting one of the locations (e.g., cities) 634, 636, 638, 640 in the sub-region, the GUI 640 shown in FIG. 6D can be displayed that can include a listing of CSP test devices located in the selected location (e.g., city). In FIG. 6D, a number of tabs can be provided to view the CSP devices in the location, for example, a tab 652 for the total devices in the location, a tab 654 for the idle devices in the location, and a tab 656 for the busy devices in the location. In FIG. 6D, the tab 652 has been selected and a listing of all of the devices in the selected location is shown. The listing can include information regarding each device including, for example, a device number (#) 662 based in the number of devices in the location, i.e., a first device, a second deice, etc. In addition, the device information illustrated in FIG, 6D can include a model 664, a device ID 666, a status 668 of a device (e.g., idle, busy, etc.), an operating system (OS) 670 of the device, and the location of the device 672 (e.g., a city). The GUI 650 also illustrates actions 658 that can be taken with respect to each device, for example, by selecting a view device 658, 660 input, an operator can view a specific CSP test device in the listing.

In response to an operator selecting one of the listed devices in the GUI 650, the GUI 680 shown in FIG. 6E can be displayed that provides additional device details for the selected CSP test device and can be used to request or view a report or analysis based on testing data associated with the selected CSP device. In FIG. 6E, a number of tabs can be provided to view different types of information associated with the selected CSP test device including device information 682, radio logs 684, a device map 686 (e.g., to view a map illustrated the location of the selected device), and reporting and analysis 688 (e.g., to request and view reports and analysis of the testing data associated with the selected CSP test device). In FIG. 6E, the tab 652 (Device Info) has been selected and various types of information associated with the selected CSP test device can be shown. In FIG. 6E, the information associated the selected CSP test device and testing using the selected CSP test device can include information regarding, for example, signal strength 690, network connection 691, SIM 692, hardware 693, WiFi 694, the geographic location 695 of the selected CSP test device, the battery 696 of the selected CSP test device, and platform 697.

As mentioned above, various components of the disclosed system and method may be implemented on a computer system. FIG. 7 is a schematic block diagram of an example computer system in accordance with an embodiment. The computer system 700 (e.g., a server) may include one or more processor devices 702, a display 704, one or more inputs 706, one or more communication systems 708, and memory 710. In some embodiments, processor device(s) 702 can be any suitable hardware processor or combination of processors, such as a central processing unit (CPU), a graphics processing unit (GPU), a microprocessor, an application specific integrated circuit (ASIC), field programmable gate arrays (FPGA), digital signal processors (DSPs), etc. The processor device(s) 702 may include one or more processors, processor cores, processing elements, processor clusters, or other electronic processing units. Accordingly, a processing function described as being performed by the processor device(s) 702 may include multiple processors, processor cores, processing elements, processing clusters, etc. (of the processor device(s) 702) performing aspects or portions (sub-functions) of the processing function to complete the processing function. The one or more electronic processing units of the processor device(s) 702 may include one or more microprocessors, application-specific integrated circuits (“ASICs”), or other suitable electronic device for processing data. At least in some examples, the one or more electronic processing units of the processor device(s) 702 can be co-located physically (e.g., in the same facility, building, room, rack, or computing housing) as part of the computer system 700.

In some embodiments, display 704 can include any suitable display devices, such as a computer monitor, a touchscreen, a television, etc. In some embodiments, display 704 can be omitted. In some embodiments, inputs 706 can include any suitable input devices and/or sensors that can be used to receive user input, such as a keyboard, a mouse, a touchscreen, a microphone, a graphical user interface (GUI), a voice user interface (VOI), mechanical switches, buttons, knobs, etc. and allow a user or operator to interact with the system for performing testing of a communication network. In some embodiments, inputs 706 can be omitted.

In some embodiments, communications system(s) 708 can include any suitable hardware, firmware, and/or software for communicating information over any suitable communication network (e.g., communication network 100 shown in FIG. 1). For example, communication system(s) 708 can include one or more transceivers, one or more communication chips and/or chip sets, etc. In a more particular example, communication system(s) 708 can include hardware, firmware and/or software that can be used to establish a Wi-Fi connection, a Bluetooth connection, a cellular connection an Ethernet connection, etc.

In some embodiments, memory 710 can include any suitable storage device or devices (e.g., one or more non-transitory computer readable media) that can be used to store instructions, values, etc., that can be used, for example, by processor device 702 to present content using display 704, to communicate with a communication network, to communicate with other computer systems, etc. Memory 710 can include any suitable volatile memory, non-volatile memory, storage, or any suitable combination thereof. For example, memory 710 can include RAM, ROM, EEPROM, one or more flash drives, one or more hard disks, one or more solid state drives, one or more optical drives, etc. The memory 710 may store data and/or instructions for use and execution by the computer system 700 (e.g., by the processor device(s) 702) to implement the functionality of, for example, a testing and analysis module, a first testing database, a second testing database, a user interface, etc. described herein. For example, the memory 710 may include or store the first testing database 302, the testing and reporting module 304, the user interface 306, and the second testing database 316 shown in FIG. 3. In some embodiments, the functionality described herein as being performed by the computer system 700 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodies on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on. As specific examples, a control device can include a processor, a microcontroller, a field-programmable gate array, a programmable logic controller, logic gates, etc., and other types of components that are known in the art for implementation of appropriate functionality (e.g., memory, communication systems, power sources, user interfaces, and other inputs, etc.).

Certain operations of the methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A system for performing testing of a communication network, the system comprising:
a memory that stores one or more computer readable media that includes instructions; and
one or more processor devices configured to execute the instructions of the computer readable media to:
generate a request regarding testing of the communication network;
establish a communication session with at least one communication service provider (CSP) test device in a predetermined location within the communication network;
transmit the request regarding testing of the communication network to the at least one CSP test device;
receive testing data from the at least one CSP test device;
store the testing data in a first testing database; and
generate at least one report based on the testing data.

2. The system according to claim 1, wherein the request regarding testing of the communication network is configured to initiate a test case and wherein the test case comprises one or more of a communication service of the communication network or an application executed over the communication network.

3. The system according to claim 1, wherein the at least one CSP device is located on a mobile entity.

4. The system according to claim 1, wherein the request regarding the testing of the communication network is configured to initiate collection of the testing data from the at least one CSP test device.

5. The system according to claim 3, wherein the testing data is associated with automated testing performed by the at least one CSP test device.

6. The system according to claim 5, wherein the one or more processor devices configured to further execute the instructions of the computer readable media to transmit a script regarding the automated testing to the at least one CSP test device to program the at least one CSP test device to perform the automated testing.

7. The system according to claim 1, wherein the testing data includes a mean opinion score (MOS).

8. A method for performing testing of a communication network, the method comprising:
generating a request regarding testing of the communication network;
establishing a communication session with at least one communication service provider (CSP) test device in a predetermined location within the communication network;
transmitting the request regarding testing of the communication network to the at least one CSP test device;
receiving testing data from the at least one CSP test device;
storing the testing data in a first testing database; and
generating at least one report based on the testing data.

9. The method according to claim 8, wherein the request regarding testing of the communication network is configured to initiate a test case and wherein the test case comprises one or more of a communication service of the communication network or an application executed over the communication network.

10. The method according to claim 8, wherein the at least one CSP device is located on a mobile entity.

11. The method according to claim 8, wherein the request regarding the testing of the communication network is configured to initiate collection of the testing data from the at least one CSP test device.

12. The method according to claim 11, wherein the testing data is associated with automated testing performed by the at least one CSP test device.

13. The method according to claim 12, further comprising transmitting a script regarding the automated testing to the at least one CSP test device to program the at least one CSP test device to perform the automated testing.

14. The method according to claim 8, wherein the testing data include a mean opinion score (MOS).

15. A non-transitory, computer-readable medium storing instructions that, when executed by a processor perform a set of functions for performing testing of a communication network, the set of functions comprising:
generating a request regarding testing of the communication network;
establishing a communication session with at least one communication service provider (CSP) test device in a predetermined location within the communication network;
transmitting the request regarding testing of the communication network to the at least one CSP test device;
receiving testing data from the at least one CSP test device;
storing the testing data in a first testing database; and
generating at least one report based on the testing data.

16. The non-transitory, computer-readable medium according to claim 15, wherein the request regarding testing of the communication network is configured to initiate a test case and wherein the test case comprises one or more of a communication service of the communication network or an application executed over the communication network.

17. The non-transitory, computer-readable medium according to claim 15, wherein the testing data includes a mean opinion score (MOS).

18. The non-transitory, computer-readable medium according to claim 15, wherein the request regarding the testing of the communication network is configured to initiate collection of the testing data from the at least one CSP test device.

19. The non-transitory, computer-readable medium according to claim 18, wherein the testing data is associated with automated testing performed by the at least one CSP test device.

20. The non-transitory, computer-readable medium according to claim 19, wherein the set of functions further comprises transmitting a script regarding the automated testing to the at least one CSP test device to program the at least one CSP test device to perform the automated testing.
